(19) United States
(12) Patent Application Publication
(10) Pub. No.: US 2016/0202598 A1
(43) Pub. Date: Jul. 14, 2016

(54) Omniview Camera Tower System

(71) Applicant: John A. Griffey, Boynton Beach, FL (US)

(72) Inventor: John A. Griffey, Boynton Beach, FL (US)

(21) Appl. No.: 14/989,550

(22) Filed: Jan. 6, 2016

Related U.S. Application Data
(60) Provisional application No. 62/100,995, filed on Jan. 8, 2015.

(51) Int. Cl. G03B 17/56; G03B 13/10; G03B 15/03; G03B 13/02

(52) U.S. Cl. CPC G03B 17/561; G03B 17/566; G03B 13/02; G03B 13/10; G03B 15/03

(57) ABSTRACT

An omniview camera system allows for the adjustment of the view provided by a camera. The system includes an extendable pole with a base portion as well as an extension portion that may be extended from or retracted into the base portion. A tilt motor is able to tilt an attached camera mount and a camera and a pan motor may be utilized to rotate the camera mount and the camera. The view provided by the camera may be adjusted by manipulating a view adjustment control unit. The view adjustment control unit may be used in a wired or wireless configuration. A live feed of the camera is provided via a removable viewfinder display. The base portion may be secured to a stabilizing base platform in order to ensure that the system remains stable when placed on a surface.

The current application claims a priority to the U.S. Provisional Patent application Ser. No. 62/100,995 filed on Jan. 8, 2015.

### FIELD OF THE INVENTION

The present invention relates generally to a camera system. More specifically, the present invention is an omniview camera tower system that allows for significant leverage over the perspective provided by a camera.

### BACKGROUND OF THE INVENTION

One of the most important factors in utilizing a camera to capture images or video is manipulating the placement of the camera in order to achieve the desired perspective of an image or video. This is commonly achieved by utilizing an object such as a pole, tripod, or similar accessory in order to position the camera. A pole allows a camera to be positioned at a higher elevation for an overview of a scene. Similarly, a tripod allows a camera to be fixed in a stationary position in order to capture a scene without being directly held by a photographer or videographer. However, a conventional pole and tripod are fairly limited in the amount of manipulation of a camera's perspective that is permitted. In the case of a pole, the user is generally required to physically maneuver the pole and attached camera in order to achieve the desired perspective, while a tripod is simply set up with a camera and left in place.

The present invention is an omniview camera tower system that greatly increases the control over a camera's perspective when capturing images or video. The present invention enables the user to position a camera in an elevated and/or extended position as well as further adjust the perspective of the camera by panning, tilting, and otherwise manipulating the camera. The present invention may be physically held by the user during use or alternatively, the present invention may be left in a stationary position during use. The present invention may be used to manipulate the perspective of the camera in both configurations of use.

### BRIEF DESCRIPTION OF THE DRAWINGS

FIG. 1 is a front perspective view of the present invention.

FIG. 2 is a rear perspective view of the present invention.

FIG. 3 is a front view of the present invention.

FIG. 4 is a cross-sectional view of the present invention taken along line A-A of FIG. 3.

FIG. 5 is a front perspective view of the base portion.

FIG. 6 is a front perspective view of the extension portion.

FIG. 7 is a front perspective view of the stabilizing base platform.

FIG. 8 is a diagram of the electronic and electrical connections of the present invention.

FIG. 9 is a diagram of the wireless connections of the present invention.

FIG. 10 is a front perspective view of a wireless configuration of the present invention.

### DETAIL DESCRIPTIONS OF THE INVENTION

All illustrations of the drawings are for the purpose of describing selected versions of the present invention and are not intended to limit the scope of the present invention.

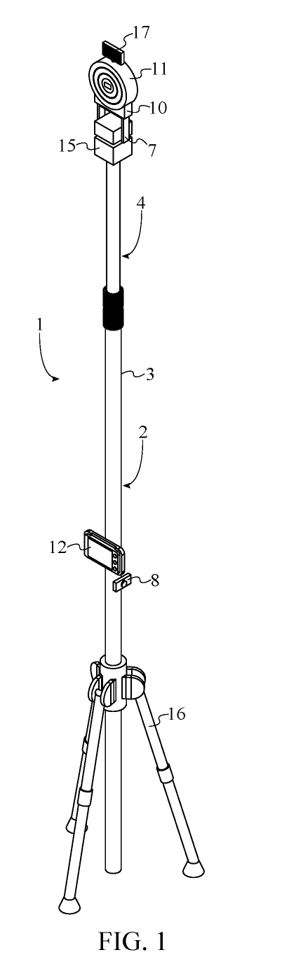

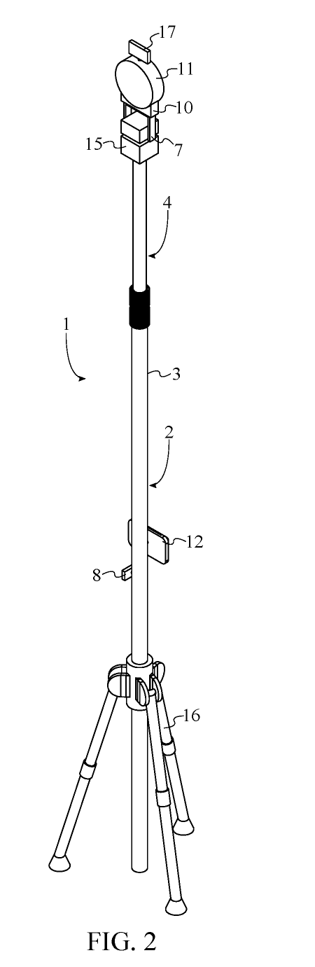

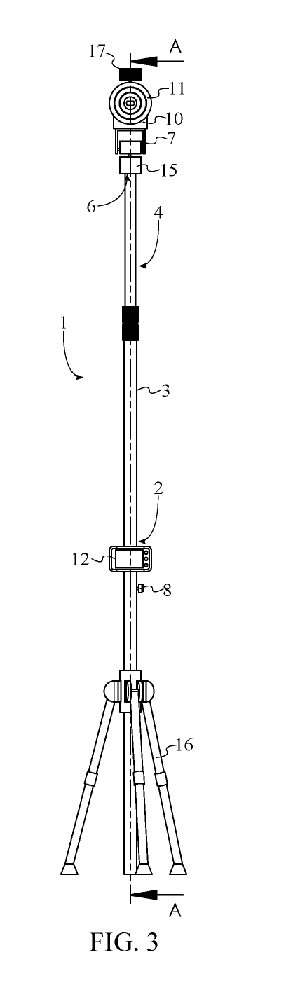

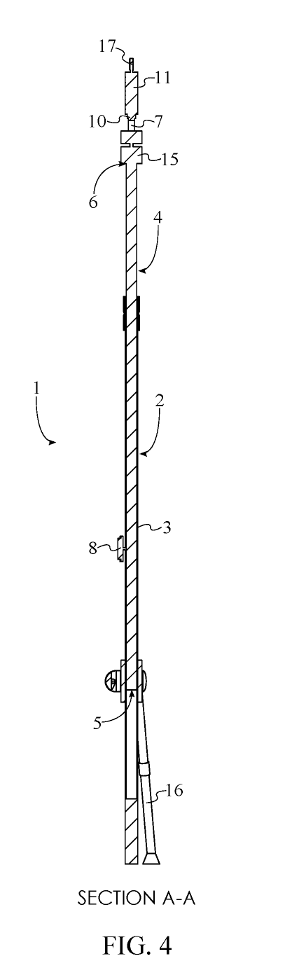

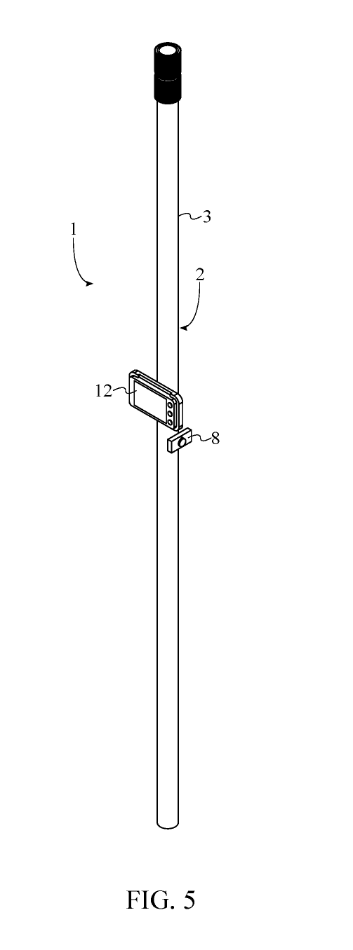

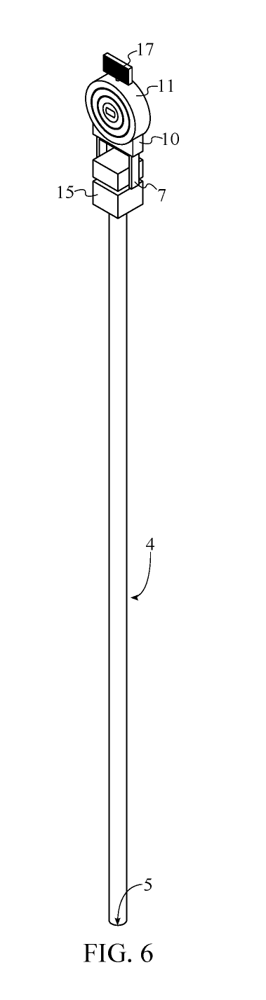

The present invention is an omniview camera tower system that provides the user with a large degree of leverage over the perspective provided by a camera. The present invention is shown in FIGS. 1-4 and comprises an extendable pole 1, a tilt motor 7, a view adjustment control unit 8, at least one power supply 9, and a camera mount 10. The extendable pole 1 is a two-piece elongated device to which a camera 11 may be mounted in order to position the camera 11 at a distance away from the user while being held or to position the camera 11 in a stationary configuration in a desired location. The extendable pole 1 comprises a base portion 2 and an extension portion 4. The base portion 2 is shown individually in FIG. 5 and is the portion of the extendable pole 1 from which the extension portion 4 is able to protrude and extend as shown in FIGS. 1-4. The extension portion 4 is shown individually in FIG. 6 and is the portion of the extendable pole 1 that is extended or retracted to modify the length of the extendable pole 1. As shown in FIGS. 1-4, the extension portion 4 is telescopically and rotatably engaged into the base portion 2. A proximal end 5 of the extension portion 4 is positioned within the base portion 2. This ensures that the extension portion 4 remains within the base portion 2 while allowing the extension portion 4 to protrude from the base portion 2 as needed when adjusting the length of the extendable pole 1. Once the extendable pole 1 has reached the desired length, the user may lock the extension portion 4 in place within the base portion 2 to fix the length of the extendable pole 1.

Again with reference to FIGS. 1-6, the tilt motor 7 enables the camera 11 to tilt upward and downward in order to adjust the view provided by the camera 11. The tilt motor 7 is mounted adjacent to a distal end 6 of the extension portion 4, enabling the tilt motor 7 to be extended and retracted along with the extension portion 4. The camera mount 10 holds the camera 11 in place on the present invention during use. The camera mount 10 is adjacently connected to the tilt motor 7, allowing the camera mount 10 and the attached camera 11 to tilt as desired when adjusting the view provided by the camera 11. The camera 11 is removably mounted to the camera mount 10, allowing the user to remove and replace the camera 11 as desired.

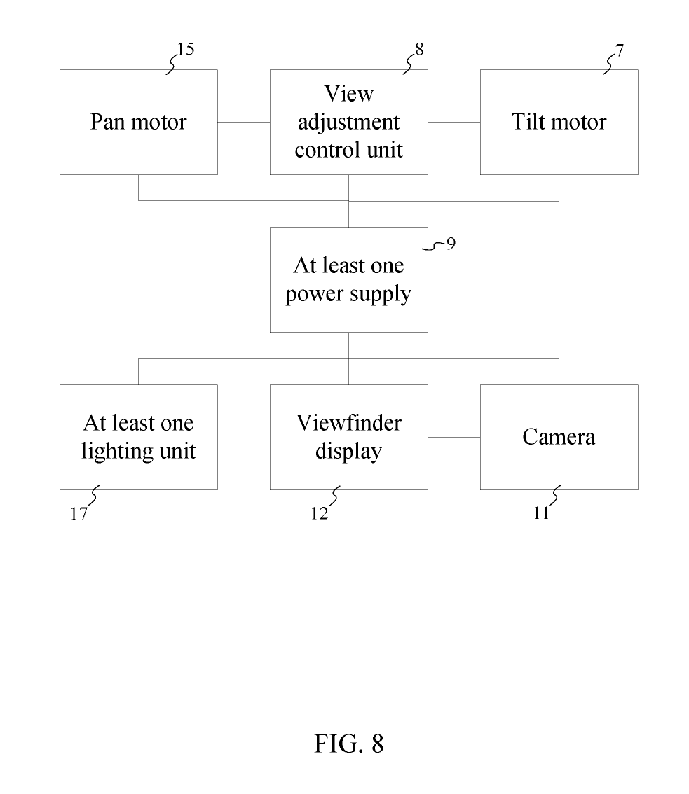

With continued reference to FIGS. 1-6 and with reference to FIG. 8, the view adjustment control unit 8 is the device that enables the user to adjust the view provided by the camera 11. The view adjustment control unit 8 is electronically connected to the tilt motor 7 in order to enable commands inputted by the user to be translated to view adjustments by the tilt motor 7. The present invention is not limited with respect to the view adjustment control unit 8. The view adjustment control unit 8 may include a series of buttons or knobs that may be physically manipulated. Alternatively, the view adjustment control unit 8 may be a digital controller. In the case of a digital controller, the user may input numerical values in order to achieve the desired view provided by the camera 11.

With further reference to FIG. 8, the at least one power supply 9 provides electrical power to the electronic components of the present invention. The tilt motor 7 and the view adjustment control unit 8 are electrically connected to the at least one power supply 9 and as such, the tilt motor 7 and the view adjustment control unit 8 are able to draw electrical power from the at least one power supply 9. Examples for the at least one power supply 9 include, but are not limited to, a replaceable battery and a rechargeable battery. Alternatively, the at least one power supply 9 may be an external power source to which the present invention is electrically connected.

Again with reference to FIGS. 1-6 and FIG. 8, the present invention further comprises a viewfinder display 12. The viewfinder display 12 provides a live view of the perspective of the camera 11. The viewfinder display 12 is electronically connected to the camera 11. This allows the viewfinder display 12 to update and adjust in real-time as the user adjusts the perspective of the camera 11 through the view adjustment control unit 8. The present invention is not limited with respect to the viewfinder display 12. In the preferred embodiment of the present invention, the viewfinder display 12 is a smartphone, tablet computer, or similar electronic device with a digital display that is able to output the live view provided by the camera 11. The electronic device may utilize a software application in order to synchronize with the camera 11. The viewfinder display 12 is removably mounted to an exterior surface 3 of the base portion 2, allowing the user to utilize any type of viewfinder display 12 as desired. The camera 11 and the viewfinder display 12 are electrically connected to the at least one power supply 9, enabling the camera 11 and the viewfinder display 12 to draw electrical power from the at least one power supply 9.

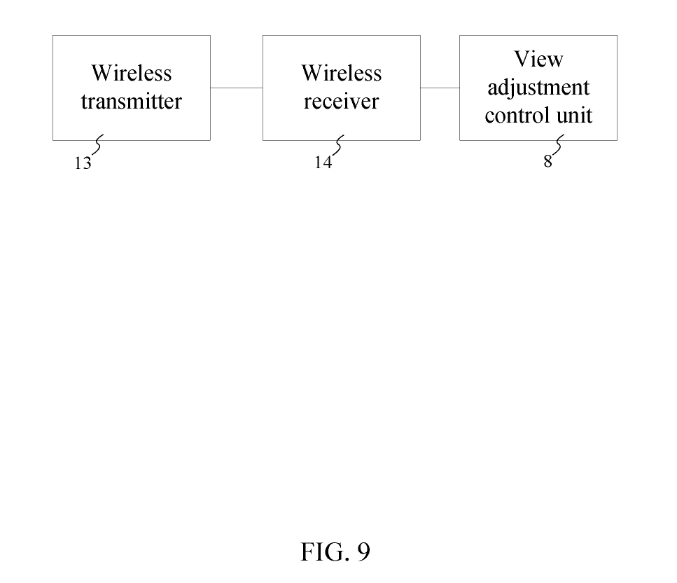

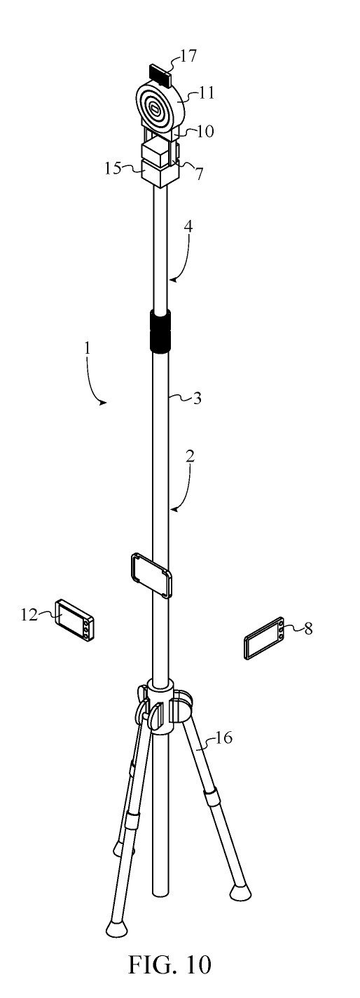

The view adjustment control unit 8 as previously discussed is designed as a wired configuration in which the user is required to be in close physical proximity to the present invention when adjusting the view provided by the camera 11. In the wired configuration, the view adjustment control unit 8 is adjacently connected to an exterior surface 3 of the base portion 2. The user is thus able to stand in close physical proximity to the present invention when adjusting the view provided by the camera 11. However, the present invention may be implemented in a wireless configuration as well. In this case, the present invention further comprises a wireless transmitter 13 and a wireless receiver 14 as shown in FIG. 9. With reference to FIG. 8, FIG. 9, and FIG. 10, the wireless transmitter 13 and the wireless receiver 14 enable the view adjustment control unit 8 to be utilized wirelessly. The user is thus able to remotely adjust the view provided by the camera 11 without being in close physical proximity to the present invention. The wireless transmitter 13 is communicatively coupled to the wireless receiver 14, enabling wireless commands to be communicated from the wireless transmitter 13 to the wireless receiver 14. The wireless receiver 14 is electronically connected to the view adjustment control unit 8. The wireless commands are thus received through the wireless receiver 14 and relayed to the view adjustment control unit 8. The view adjustment control unit 8 is then able to adjust the view provided by the camera 11 accordingly. In the wireless configuration, the view adjustment control unit 8 is removably attached to the exterior surface 3. The user is thus able to remotely adjust the view provided by the camera 11. The present invention may utilize wireless protocols including, but not limited to, Wi-Fi, ZigBee, and Bluetooth. Various types of wireless protocols may be utilized based on the range requirements for wireless control of the present invention.

Again with reference to FIGS. 1-4 and FIG. 8, the present invention further comprises a pan motor 15. The pan motor 15 enables the camera 11 to rotate in the horizontal plane. In conjunction with the tilt motor 7, the pan motor 15 provides greater control for the view provided by the camera 11. The pan motor 15 is positioned in between the tilt motor 7 and the distal end 6, enabling the pan motor 15 to rotate the tilt motor 7 as well as the camera mount 10 and the camera 11. Additionally, the tilt motor 7 is operatively engaged to the pan motor 15. The tilt motor 7 is thus able to rotate along with the pan motor 15. The functionality of the tilt motor 7 is not impeded by the pan motor 15. The pan motor 15 is electronically connected to the view adjustment control unit 8. Commands inputted by the user through the view adjustment control unit 8 are thus translated to view adjustments by the pan motor 15. The pan motor 15 is electrically connected to the at least one power supply 9, allowing the pan motor 15 to draw electrical power from the at least one power supply 9. As with the tilt motor 7, the pan motor 15 may be wirelessly controlled by the view adjustment control unit 8.

Various embodiments of the present invention may not include a pan motor 15. In the absence of a pan motor 15, the user may exert the same panning effect provided by the pan motor 15 by manually rotating the extension portion 4 within the base portion 2. The extension portion 4 may then be locked in place in order to fix the view provided by the camera 11.

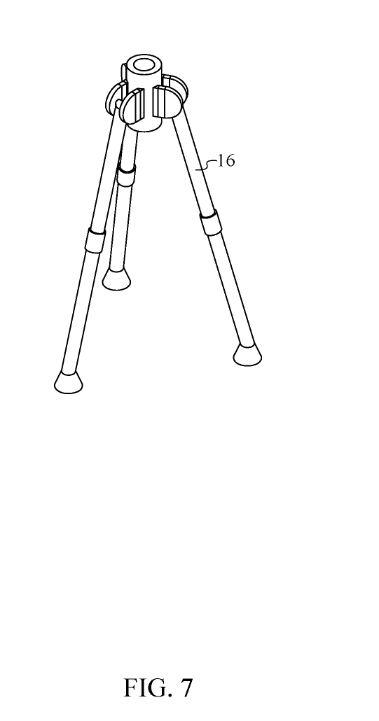

During use, the present invention may be held by the user for mobility or placed in a stationary position in a fixed location. As such, the present invention further comprises a stabilizing base platform 16. The stabilizing base platform 16 is shown in FIG. 7 and provides stability for the present invention when the present invention is placed on a surface. The base portion 2 is slidably and removably engaged into the stabilizing base platform 16 as shown in FIGS. 1-4. This enables the base portion 2 to come into contact with the surface on which the stabilizing base platform 16 is resting for additional stability of the present invention. In the preferred embodiment of the present invention, the stabilizing base platform 16 is a tripod. The tripod may be replaced by or include a pole stake or similar device that may be utilized to anchor the stabilizing base platform 16 to a surface.

The present invention further comprises at least one lighting unit 17. The at least one lighting unit 17 is utilized to provide lighting in the vicinity of the present invention. The at least one lighting unit 17 may be oriented in a single direction, multiple directions, or provide ambient lighting to a full 360 degrees around the present invention. The at least one lighting unit 17 is adjacently and removably mounted to a camera 11. The user is thus able to remove and replace the at least one lighting unit 17 as needed. The at least one lighting unit 17 is electrically connected to the at least one power supply 9, enabling the at least one lighting unit 17 to draw electrical power from the at least one power supply 9.

Although the present invention has been explained in relation to its preferred embodiment, it is understood that many other possible modifications and variations can be made without departing from the spirit and scope of the present invention as hereinafter claimed.

What is claimed is:

1. An omniview camera tower system comprises:
an extendable pole;
a tilt motor;
a view adjustment control unit;
at least one power supply;
a camera mount;
the extendable pole comprises a base portion and an extension portion;
the extension portion being telescopically and rotatably engaged into the base portion, wherein a proximal end of the extension portion is positioned within the base portion;
the tilt motor being mounted adjacent to a distal end of the extension portion;
the camera mount being adjacently connected to the tilt motor;
the view adjustment control unit being electronically connected to the tilt motor; and
the tilt motor and the view adjustment control unit being electrically connected to the at least one power supply.

2. The omniview camera tower system as claimed in claim 1 further comprises:
a camera;
a viewfinder display;
the camera being removably mounted to the camera mount;
the viewfinder display being electronically connected to the camera;
the viewfinder display being removably mounted to an exterior surface of the base portion; and
the camera and the viewfinder display being electrically connected to the at least one power supply.

3. The omniview camera tower system as claimed in claim 1 further comprises:
a wireless transmitter;
a wireless receiver;
the wireless transmitter being communicatively coupled to the wireless receiver;
the wireless receiver being electronically connected to the view adjustment control unit; and
the view adjustment control unit being removably attached to an exterior surface of the base portion.

4. The omniview camera tower system as claimed in claim 1 further comprises:
the view adjustment control unit being adjacently connected to an exterior surface of the base portion.

5. The omniview camera tower system as claimed in claim 1 further comprises:
a pan motor;
the pan motor being positioned in between the tilt motor and the distal end;
the tilt motor being operatively engaged to the pan motor;
the pan motor being electronically connected to the view adjustment control unit; and
the pan motor being electrically connected to the at least one power supply.

6. The omniview camera tower system as claimed in claim 5 further comprises:
a wireless transmitter;
a wireless receiver;
the wireless transmitter being communicatively coupled to the wireless receiver;
the wireless receiver being electronically connected to the view adjustment control unit; and
the view adjustment control unit being removably attached to an exterior surface of the base portion.

7. The omniview camera tower system as claimed in claim 5 further comprises:
the view adjustment control unit being adjacently connected to an exterior surface of the base portion.

8. The omniview camera tower system as claimed in claim 1 further comprises:
a stabilizing base platform; and
the base portion being slidably and removably engaged into the stabilizing base platform.

9. The omniview camera tower system as claimed in claim 8, wherein the stabilizing base platform is a tripod.

10. The omniview camera tower system as claimed in claim 1 further comprises:
at least one lighting unit;
the at least one lighting unit being adjacently and removably mounted to a camera; and
the at least one lighting unit being electrically connected to the at least one power supply.

11. An omniview camera tower system comprises:
an extendable pole;
a tilt motor;
a view adjustment control unit;
at least one power supply;
a camera mount;
a pan motor;
the extendable pole comprises a base portion and an extension portion;
the extension portion being telescopically and rotatably engaged into the base portion, wherein a proximal end of the extension portion is positioned within the base portion;
the tilt motor being mounted adjacent to a distal end of the extension portion;
the camera mount being adjacently connected to the tilt motor;
the view adjustment control unit being electronically connected to the tilt motor;
the tilt motor and the view adjustment control unit being electrically connected to the at least one power supply;
the pan motor being positioned in between the tilt motor and the distal end;
the tilt motor being operatively engaged to the pan motor;
the pan motor being electronically connected to the view adjustment control unit; and
the pan motor being electrically connected to the at least one power supply.

12. The omniview camera tower system as claimed in claim 11 further comprises:
a camera;
a viewfinder display;
the camera being removably mounted to the camera mount;
the viewfinder display being electronically connected to the camera;
the viewfinder display being removably mounted to an exterior surface of the base portion; and
the camera and the viewfinder display being electrically connected to the at least one power supply.

13. The omniview camera tower system as claimed in claim 11 further comprises:
a wireless transmitter;
a wireless receiver;
the wireless transmitter being communicatively coupled to the wireless receiver;
the wireless receiver being electronically connected to the view adjustment control unit; and
the view adjustment control unit being removably attached to an exterior surface of the base portion.

14. The omniview camera tower system as claimed in claim 11 further comprises:
the view adjustment control unit being adjacently connected to an exterior surface of the base portion.

15. The omniview camera tower system as claimed in claim 11 further comprises:
a stabilizing base platform; and
the base portion being slidably and removably engaged into the stabilizing base platform.

16. The omniview camera tower system as claimed in claim 15, wherein the stabilizing base platform is a tripod.

17. The omniview camera tower system as claimed in claim 11 further comprises:
at least one lighting unit;
the at least one lighting unit being adjacently and removably mounted to a camera; and
the at least one lighting unit being electrically connected to the at least one power supply.
